(19) United States
(12) Patent Application Publication
(10) Pub. No.: US 2005/0237144 A1
(43) Pub. Date: Oct. 27, 2005

(54) Planar inductance

(75) Inventors: Josef Einzinger, Georgensgmuend (DE); Andreas Loth, Neu-Ulm (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLIPS ELECTRONICS N.V.

(21) Appl. No.: 10/521,854

(22) PCT Filed: Jul. 16, 2003
(86) PCT No.: PCT/IB03/03227

§ 371 Date: Jan. 21, 2005

(30) Foreign Application Priority Data
Jul. 25, 2002 (DE) 10233980.5

(51) Int. Cl. H01F 5/00

(52) U.S. Cl. 336/200

(57) ABSTRACT

A planar inductance, in particular for monolithic HF oscillators, with planar spiral windings, wherein each winding (1) is in the form of an “eight” with three cross-conductors (6, 7, 8) carrying current in the same direction and running between two loops (1a, 1b).

The invention relates to a planar inductance, in particular for monolithic HF oscillators with planar spiral windings.

Normally, in the planar inductances known hitherto, the windings are in the form of essentially closed loops, e.g. any polygons that can assume an elliptical form in the boundary area, or may also be circular in shape, wherein, for connection of the power supply lines, the intersecting winding ends form conductor sections running, in sections, in parallel with each other and carrying current in the same direction. The disadvantage of these known structures consists in the fact that a strong magnetic field component evolves outside the winding loop. In the case of integrated circuits, such as transceiver ICs in mobile communications or in data transmission technology, which comprise further magnetic elements internally or in the external wiring, including parasitic elements if applicable—as is the case in interface circuits for LNAs, for example—interfering couplings may occur with a spiral inductance of this kind. In its turn, this may express itself in undesired oscillations, excessively high crosstalk of the relevant frequency components or similar.

It is therefore an object of the invention to create a planar inductance which, with a structure of similar simplicity to the planar inductances known hitherto, has a reduced magnetic field component outside the windings.

To achieve this object, the invention provides that each winding is in the form of an “eight” with three cross-conductors carrying current in the same direction and running between two loops.

Thanks to the design in accordance with the invention, in which each spiral winding comprises two loops, one of which carries current clockwise and the other counterclockwise, the surface requirement is similar to that for the known structures, and roughly identical inductance and performance factor values arise. The opposing magnetic flow directions in the two loops of the winding ensure that the greater part of the magnetic flow concentrates around the three central cross-conductors. The magnetic dipoles of the mutual windings lead to a good local positioning of the magnetic field components. Outside the windings, therefore, the field is considerably reduced in comparison with the structures used hitherto. Measurement results of a self-mixing effect between a fully integrated RF-VCO and a high-frequency receiving circuit, brought about by these magnetic field components, indicate a reduction of around 10 dB for the new structure as compared with the one used hitherto. Finally, it is also within the scope of the invention that the cross-conductors are located parallel with each other, and the top and bottom ones are joined to the power supply lines on opposite sides. These cross-conductors may also be located one above the other.

The planar inductance in accordance with the invention may, of course, also be in the form of multiple windings. To this end, in an embodiment of the invention, each eye of the winding may be equipped with multiple windings, arranged spirally inside one another, the inner ends of which are joined together.

To compensate the magnetic field of the supply lines, it may further be provided that the eye of the winding from which the supply lines depart is arranged to be smaller than the other eye, wherein, to this end, an additional metallization plane may be provided, if appropriate, and the central conductors are, in part, located one above the other.

The invention will be further described with reference to examples of embodiments shown in the drawings, to which, however, the invention is not restricted.

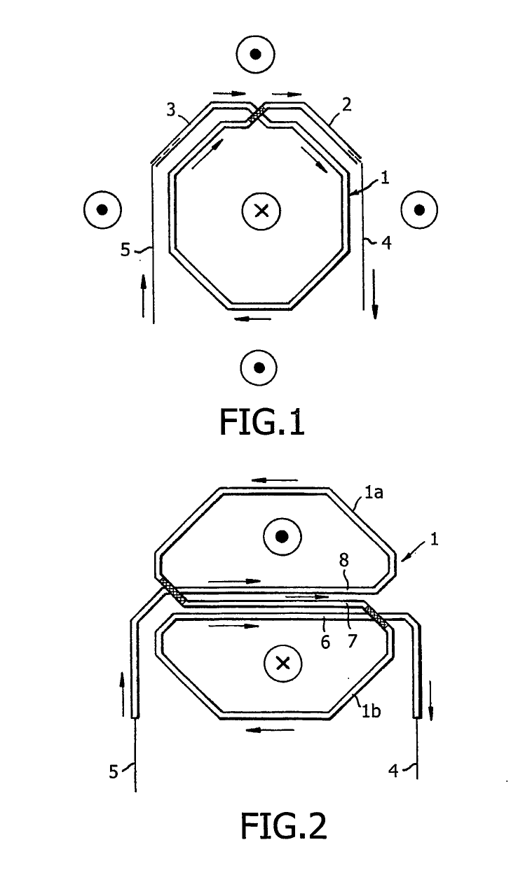

FIG. 1 shows a representation of a typical planar inductance in accordance with the prior art.

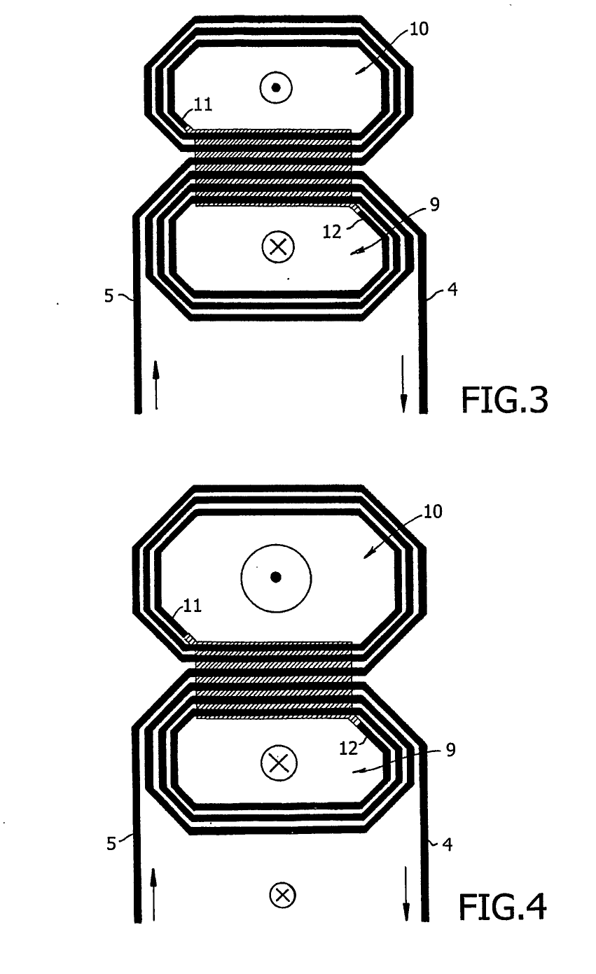

FIG. 2 shows a representation of the structure of a planar inductance in accordance with the invention.

FIGS. 3 to 5 show examples of embodiments of a planar inductance with multiple windings.

The winding for a planar inductance in accordance with the prior art as shown in FIG. 1 comprises a ring-shaped loop 1, the ends 2 and 3 of which, crossing over each other, are routed outwards and joined to the power supply lines 4 and 5, or to further loops in the case of multiple windings. As a result of the current flow, indicated by arrows, a strong magnetic field is created outside of the actual winding 1, which—as explained in detail above—has an interfering effect in many application instances.

In accordance with the invention, therefore, a modified structure is depicted, as shown in FIG. 2, with its winding 1 in the form of a figure “8” with two loops 1a and 1b, wherein three cross-conductors 6 to 8, carrying current in the same direction, are formed between the two loops 1a and 1b. These cross-conductors 6 to 8 are located parallel with each other, wherein the top cross-conductor 8 and the bottom cross-conductor 6 are joined on opposite sides to the power supply lines 4 and 5. It hereby goes without saying that crossovers of the planar spiral windings are, of course, insulated.

The magnetic dipoles of the opposed-direction winding loops 1a and 1b give rise to an extremely good local positioning of the magnetic field components, so that virtually no appreciable magnetic field components any longer occur outside of the winding loops.

FIG. 3 shows an example of embodiment of a planar inductance with multiple windings. Here, the conductor layout is arranged in such a way that, starting from supply line 5 of the bottom eye 9, the top eye 10 is firstly wound in such a way that the conductor tracks are arranged spirally inside each other. The end 11 of the inner winding of the top eye 10 is joined to the end 12 of the inner winding of the bottom eye 9.

To compensate the magnetic field of supply lines 4 and 5, in the example of embodiment shown in FIG. 4, the top eye 10 of the planar inductance is arranged to be larger.

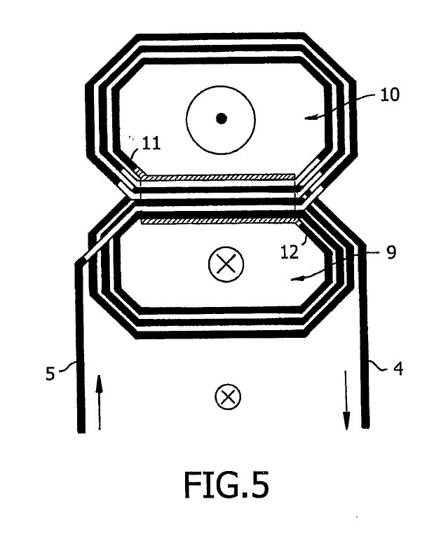

In the embodiment example shown in FIG. 5, in which the top eye 10, i.e. the eye without supply lines 4 and 5, is again arranged to be larger, this is achieved in that an additional metallization plane is provided, and the central conductors are, in part, located one above the other.

1. A planar inductance, in particular for monolithic HF oscillators, with planar spiral windings, characterized in that each winding (1) is in the form of an “eight” with three cross-conductors (6, 7, 8) carrying current in the same direction and running between two loops (1a, 1b).

2. A planar inductance as claimed in claim 1, characterized in that the cross-conductors (6, 7, 8) are located parallel with each other, and the top (8) and bottom (6) ones are joined to the power supply lines (4, 5) on opposite sides.

3. A planar inductance as claimed in claim 1 or 2, characterized in that each eye (9, 10) of the winding is equipped with multiple windings, arranged spirally inside one another, the inner ends (11, 12) of which are joined together.

4. A planar inductance as claimed in claim 3, characterized in that the eye (9) of the winding adjacent to which the supply lines (4, 5) run is arranged to be smaller than the other eye (10) in order to compensate the magnetic field of the supply lines (4, 5).

5. A planar inductance as claimed in claim 4, characterized in that an additional metallization plane is provided, and the central conductors are, in part, located one above the other.
